(19) United States
(12) Patent Application Publication
(10) Pub. No.: US 2020/0185968 A1
(43) Pub. Date: Jun. 11, 2020

(54) RECHARGEABLE BATTERY AND HEARING AID SYSTEM

(71) Applicant: HANA MICROELECTRONIC INC, Santa Clara, CA (US)

(72) Inventors: IN SUK KIM, BANGKOK (TH); Chwee Heng Teo, Bangkok (TH)

(73) Assignee: Hana Microelectronic Inc, Santa Clara, CA (US)

(21) Appl. No.: 16/677,587

(22) Filed: Nov. 7, 2019

Related U.S. Application Data
(60) Provisional application No. 62/757,667, filed on Nov. 8, 2018.

(51) Int. Cl. H02J 50/12; H04R 25/00; H01M 2/02; H02J 7/00

(52) U.S. Cl. CPC H02J 50/12; H04R 25/602; H04R 2225/31; H02J 7/0044; H01M 2/0202

(57) ABSTRACT

Disclosed is a wireless rechargeable battery and hearing aid system. In some embodiments, a base can comprise a housing chamber and a power source. In some embodiments and a power source can be interchangeable and removably coupled to a housing chamber via a slidable coupling mechanism comprising a tongue-and-groove configuration, but in other embodiments can have a click-fit, friction-fit, or any other known and convenient device. In operation, a hearing aid can rest inside a housing chamber proximal to and in electrical communication with a power source, which can charge a battery in a hearing aid.

### CLAIM OF PRIORITY

### Cross-Reference to Related Application(S)

This application claims the benefit of priority of prior-filed and co-pending U.S. Provisional Application Ser. No. 62/757,667, filed Nov. 8, 2018, the entirety of which is hereby incorporated herein by reference.

### BACKGROUND

### Technical Field

The present device relates to the field of hearing aids and more specifically to a rechargeable hearing aid system.

### Background

Hearing enhancement devices have existed for a long time. Over the years, electronic hearing aids have become smaller and smaller. However, these tiny electronic devices require batteries to power them. It is an unfortunate truth there are many elderly people with poor or failing eyesight that must use these small hearing aids and change the batteries in them. Due to the size of the devices, the batteries in the devices are also equally small. This creates significant problems for those with poor or failing eyesight. As a result, rechargeable hearing aids were created. However, again, these require that individual plug them in to a charging cable view what is usually a very small charging port. What is needed is a hearing aid system with rechargeable batteries and a charging system that does not require fine motor skill and/or good eyesight in order to use/charge the hearing aid(s).

### BRIEF DESCRIPTION OF THE DRAWINGS

Further details of the present device are explained with the help of the attached drawings in which:

FIGS. 1a-1c depict an embodiment of a wireless rechargeable battery and hearing aid system.

FIG. 2a depicts a perspective view of an embodiment of a battery housing in the present system.

FIG. 2b depicts a top view of the battery housing embodiment shown in FIG. 2a.

FIG. 2c depicts a bottom view of the battery housing embodiment shown in FIG. 2a.

FIG. 2d depicts a first side view of the battery housing embodiment shown in FIG. 2a.

FIG. 2e depicts a second side view of the battery housing embodiment shown in FIG. 2a.

FIG. 2f depicts a third side view of the battery housing embodiment shown in FIG. 2a.

FIG. 2g depicts a fourth side view of the battery housing embodiment shown in FIG. 2a.

FIG. 3 depicts a perspective expanded view of an embodiment of a battery housing unit in the present system.

FIG. 4a depicts a perspective view of an embodiment of a battery housing in the present system.

FIG. 4b depicts a top view of the battery housing embodiment shown in FIG. 4a.

FIG. 4c depicts a bottom view of the battery housing embodiment shown in FIG. 4a.

FIG. 4d depicts a first side view of the battery housing embodiment shown in FIG. 4a.

FIG. 4e depicts a second side view of the battery housing embodiment shown in FIG. 4a.

FIG. 4f depicts a third side view of the battery housing embodiment shown in FIG. 4a.

FIG. 4g depicts a fourth side view of the battery housing embodiment shown in FIG. 4a.

FIG. 5 depicts a perspective expanded view of another embodiment of a battery housing unit in the present system.

FIG. 6 depicts a perspective expanded view of an embodiment of a battery housing unit used in a hearing aid in the present system.

FIG. 7a depicts a perspective view of an embodiment of a battery housing in the present system.

FIG. 7b depicts a top view of the battery housing embodiment shown in FIG. 8a.

FIG. 7c depicts a bottom view of the battery housing embodiment shown in FIG. 8a.

FIG. 7d depicts a first side view of the battery housing embodiment shown in FIG. 8a.

FIG. 7e depicts a second side view of the battery housing embodiment shown in FIG. 8a.

FIG. 7f depicts a third side view of the battery housing embodiment shown in FIG. 8a.

FIG. 7g depicts a fourth side view of the battery housing embodiment shown in FIG. 8a.

FIG. 8 depicts a perspective expanded view of another embodiment of a battery housing unit in the present system.

FIG. 9 depicts a perspective expanded view of another embodiment of a battery housing unit used in a hearing aid in the present system.

FIG. 10a depicts a perspective view of an embodiment of a charging case in an open configuration in the present system.

FIG. 10b depicts a front view of the charging case embodiment shown in FIG. 10a.

FIG. 10c depicts a rear view of the charging case embodiment shown in FIG. 10a.

FIG. 10d depicts a first side view of the charging case embodiment shown in FIG. 10a.

FIG. 10e depicts a second side view of the charging case embodiment shown in FIG. 10a.

FIG. 10f depicts a top view of the charging case embodiment shown in FIG. 10a.

FIG. 10g depicts a bottom view of the charging case embodiment shown in FIG. 10a.

FIG. 10h depicts a top perspective view of an embodiment of a charging case in a closed configuration in the present system.

FIG. 10i depicts a bottom perspective view of an embodiment of a charging case in the present system.

FIG. 11a depicts a side view of an embodiment of the present system in an open configuration.

FIG. 11b depicts a side view of an embodiment of the present system in an open configuration.

FIG. 11c depicts a side view of an embodiment of the present system in a closed configuration.

FIG. 11d depicts a perspective view of an embodiment of the present system shown in FIG. 12a in an open configuration.

FIG. 12a depicts a side view of another embodiment of the present system in an open configuration.

FIG. 12b depicts a side view of another embodiment of the present system in an open configuration.

FIG. 12c depicts a side view of another embodiment of the present system in a closed configuration.

FIG. 12d depicts a perspective view of another embodiment of the present system shown in FIG. 12a in an open configuration.

FIG. 13a depicts a perspective view of another embodiment of a battery housing in the present system.

FIG. 13b depicts a top view of the battery housing and adaptor embodiment shown in FIG. 13a.

FIG. 13c depicts a bottom view of the battery housing and adaptor and adaptor embodiment shown in FIG. 13a.

FIG. 13d depicts a first side view of the battery housing and adaptor embodiment shown in FIG. 13a.

FIG. 13e depicts a second side view of the battery housing and adaptor embodiment shown in FIG. 13a.

FIG. 13f depicts a third side view of the battery housing and adaptor embodiment shown in FIG. 13a.

FIG. 13g depicts a fourth side view of the battery housing and adaptor embodiment shown in FIG. 13a.

FIG. 13h depicts a fifth side view of the battery housing and adaptor embodiment shown in FIG. 13a.

FIG. 13i depicts a sixth side view of the battery housing and adaptor embodiment shown in FIG. 13a.

FIG. 13j depicts a seventh side view of the battery housing and adaptor and adaptor embodiment shown in FIG. 13a.

FIG. 13k depicts an eighth side view of the battery housing and adaptor embodiment shown in FIG. 13a.

FIG. 14 depicts a perspective expanded view of another embodiment of a battery housing unit in the present system.

FIG. 15 depicts a perspective expanded view of another embodiment of a battery housing unit in use with a hearing aid in the present system.

FIG. 16 depicts a perspective view of another embodiment of a battery housing unit in use with a hearing aid in the present system.

### DETAILED DESCRIPTION

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

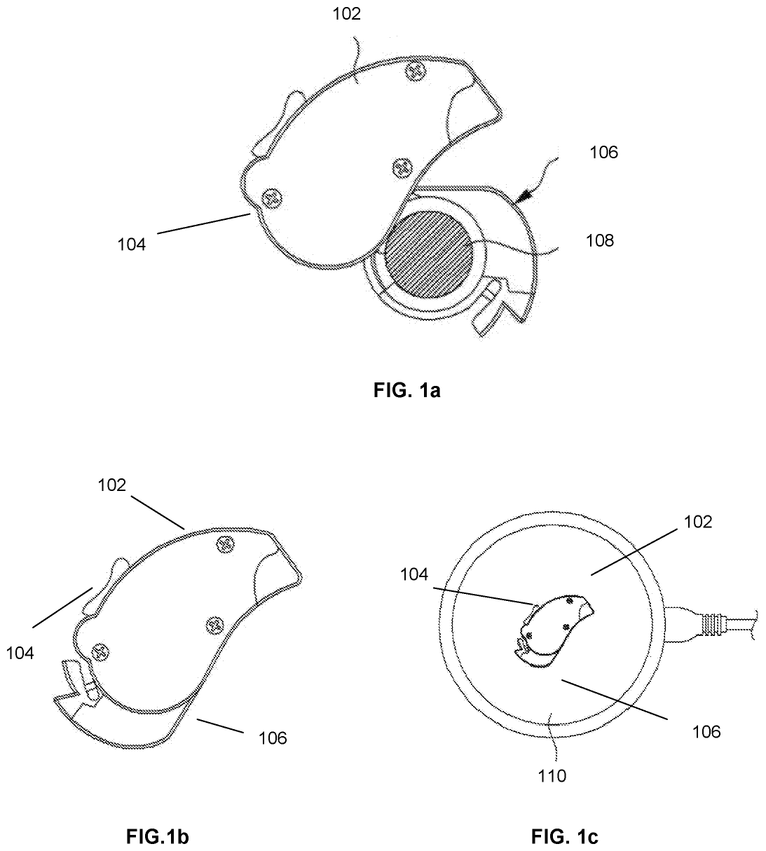

FIGS. 1a-1c depict an embodiment of a wireless rechargeable battery and hearing aid system. In FIG. 1a, a hearing aid body 102 can comprise a hearing aid housing 104, a battery housing 106, and a battery 108. In some embodiments, a battery 108 can be rechargeable. A battery 108 can have voltages ranging from approximately 1.2V to 4.2V, depending on battery type and composition, but in other embodiments can have voltages in any other known and/or convenient range. As non-limiting examples, a battery 108 can be a Lithium-ion type (4.2V), comprised of NiMH (1.2V), or comprised of Silver-Zinc (2.0V).

Battery 108 size can depend factors such as, but not limited to, hearing aid size and design, and power requirements. In some embodiments, a battery 108 can be a designed for a hearing aid (e.g., “coin-type”) and can be a size 10, 312, 13,675, or any other known and/or convenient size. Further, a battery 108 can be a “pin-type” or any other known and/or desired customized size.

As shown in FIG. 1a, a battery housing 104 can be pivotally connected to a hearing aid housing 104, but in other embodiments can be connected by any other known and/or convenient device. In such embodiments, as shown in FIG. 1b, a battery housing 106 can be selectively engaged with a hearing aid housing 104, such that a battery housing 106 can be inserted within a hearing aid housing 104. In such embodiments, a hearing aid body 102 can be opened to access a battery 108. As shown in FIG. 1c, a hearing aid 102 can be placed in functional proximity to an power source 110. In some embodiments, a power source 110 can be an inductive charging surface, but in other embodiments can be any other known and/or convenient device. In some embodiments, a hearing aid body 102 and battery housing 106 can comprise a polymer, ceramic, metal, or any other known and/or convenient material.

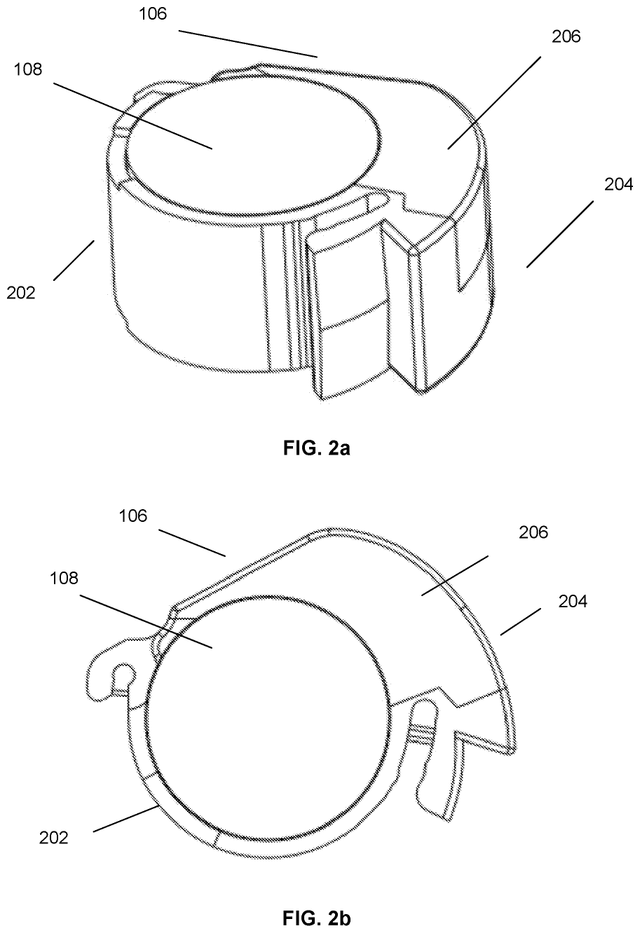

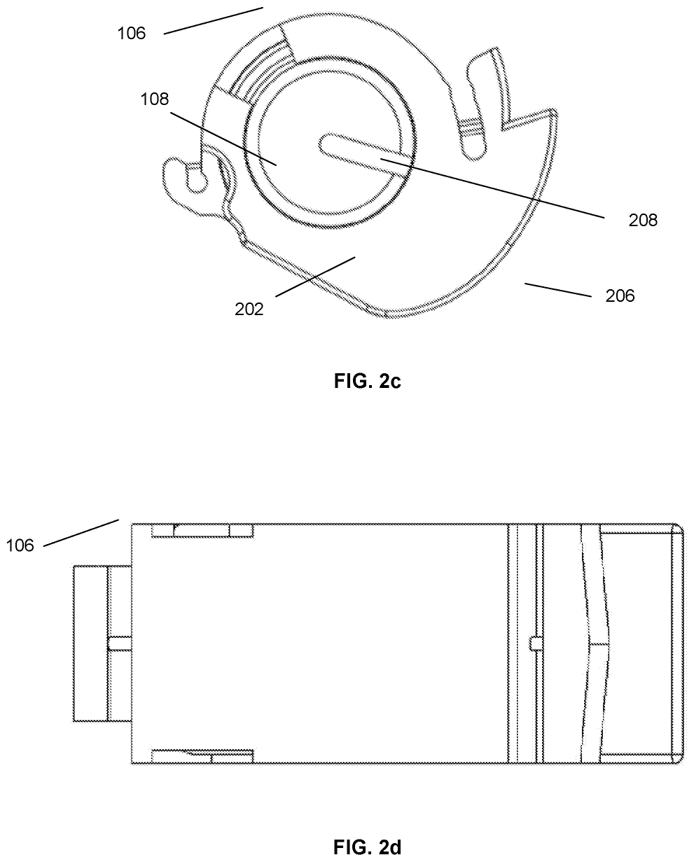

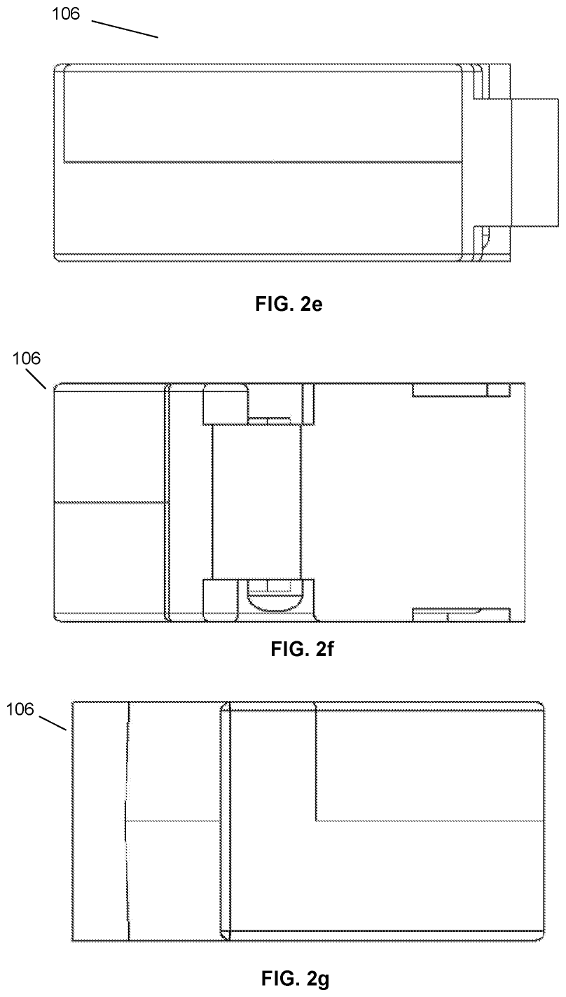

FIG. 2a depicts a perspective exterior view of a battery housing 106. As shown in FIG. 2, a battery housing 106 can further comprise a base section 202 and a protruding section 204 having a removable cover section 206. A battery housing 106 can have a partially rounded geometry to selectively engage with a hearing aid body 102, but in other embodiments can have any other known and/or convenient geometry.

FIG. 2b depicts a top view of the battery housing 106 embodiment shown in FIG. 2a. A section of a battery housing base section 202 can have a radius proportional to that of a battery 108. In such embodiments, a battery housing base section 202 can have a depth of dimension greater than that of the thickness of a battery 108. Another section 204 of a battery housing 106 can also have a substantially rounded geometry such that this section can protrude outward from a battery housing 106. A cover section 206 can selectively engage with a protruding section 204 to provide access to the interior of a battery housing 106.

FIGS. 2d-2e depict side views of the battery housing 106 embodiment shown in FIG. 2a.

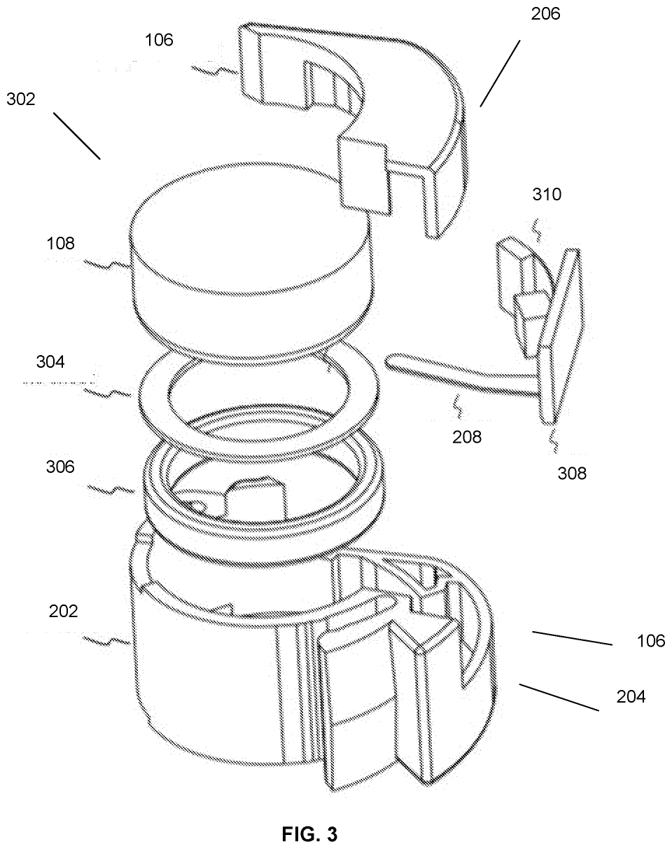

FIG. 3 depicts an expanded assembly view of a battery unit 302. In some embodiments, a battery housing 106 can contain a battery 108 having a top surface and a bottom surface. A ferrite sheet 304 having a top surface and a bottom surface can be placed adjacent to a battery 108, such that the top surface of a ferrite sheet 304 can be in contact with the bottom surface of a battery 108. In some embodiments, a ferrite sheet 304 can have a substantially annular geometry, but in other embodiments can have any other known and/or convenient geometry. An inductive coil 306 having a top surface and a bottom surface can be placed adjacent to a ferrite sheet 304, such that the top surface of an inductive coil 306 can be in contact with the bottom surface of a ferrite sheet 304. The configuration of an inductive coil 306 and ferrite sheet 304 can depend on several factors, such as, but not limited to, operating frequency and voltage, coupling efficiency between a transmitting coil in an inductive charging surface 110 and a receiving inductive coil 306, configuration of a hearing aid 102 and a rechargeable battery unit 302, and battery size. Operating frequencies can be in the range of 100 Khz to 7.0 MHz, and operating voltages can be in the range of 3.0V to 5.0V, but in other embodiments operating frequencies and voltages can be in any other known and/or convenient range; coupling efficiencies can also be in any known and/or convenient range.

A printed circuit board (PCB) 308 can comprise a first contact 208 and a second contact 310, which can be in electrical contact with a battery 108. A PCB 308 can be configured to perform several functions, such as, but not limited to, converting the power induced from the charging receiving coil 306 into direct current to charge a battery 108 and setting and controlling a battery 108. A PCB 308 can also be configured to charge voltage and/or current depending on factors such as, but not limited to, charge rate/time, as well as type and characteristics of a battery 108. A PCB 308 can also regulate output voltage of a charged battery 108 to match the operating voltage of a hearing aid 102.

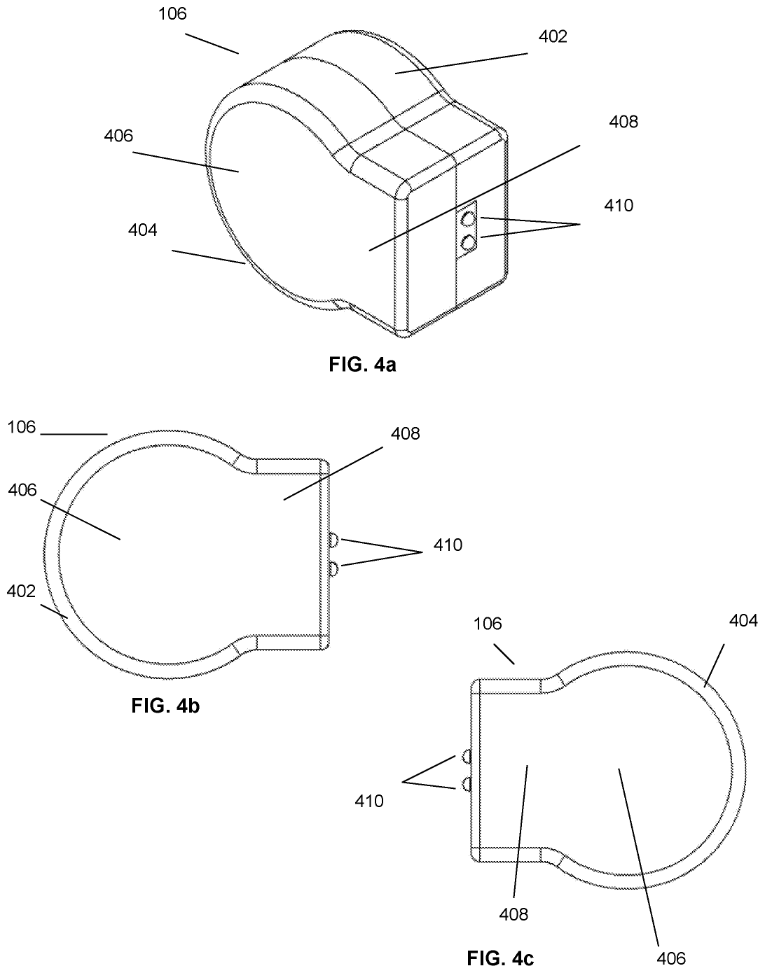

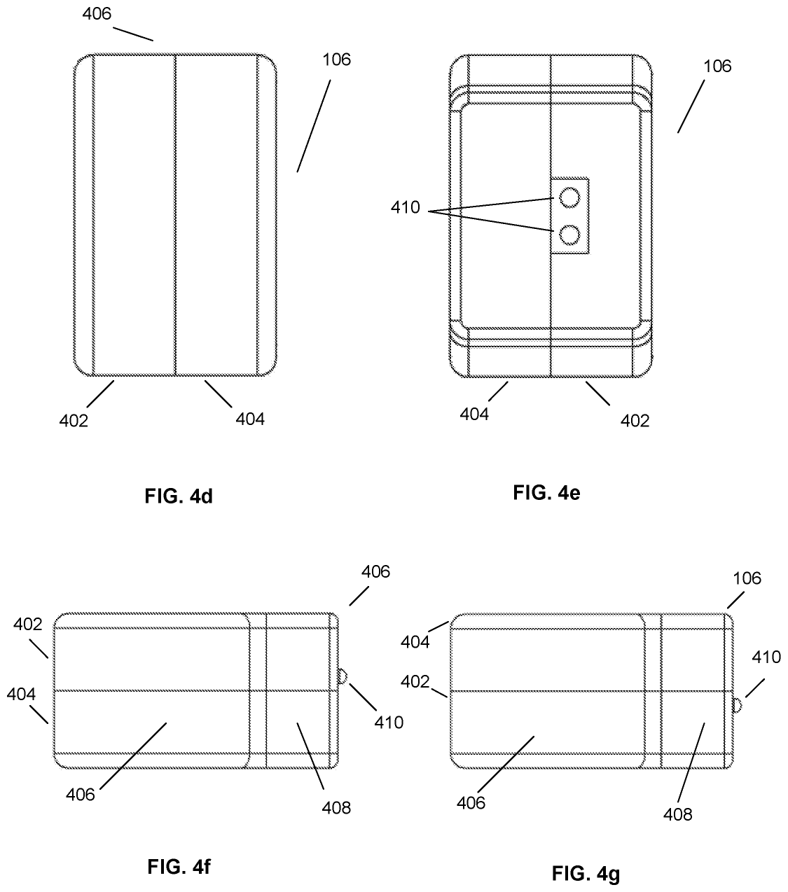

FIG. 4a depicts an exterior perspective view of another embodiment of a battery housing 106. In the embodiment shown, a battery housing 106 can comprise a first section 402 and a second section 404, which can be of substantially congruent geometry and selectively engage with each other, but in other embodiments can be any other known and/or geometry. In some embodiments, a first section 402 and a second section 404 can securely and temporarily connect via a friction fit, tab-and-slot, threaded connector, adhesive, or any other known and/or convenient mechanism.

As shown in FIG. 4a, a battery housing 106 can comprise a substantially rounded portion 406 and a protruding substantially rectangular portion 408. A rounded portion 406 can be substantially circular and have a radius substantially proportional to a battery 108, but in other embodiments can have any other known and/or convenient geometry. In such embodiments, a substantially rectangular portion 408 can extend substantially radially from a rounded portion 406, but in other embodiments can extend tangentially or in any other known and/or convenient configuration. In some embodiments, a pair of external electrical contacts 410 can be located at the distal end of a rectangular portion 408, proximal to the joint line between a first section 402 and a second section 404, but in other embodiments can be in any other known and/or convenient location.

FIG. 4b depicts a top view of the embodiment shown in FIG. 4a.

FIG. 4c depicts a bottom view of the embodiment shown in FIG. 4a.

FIG. 4d depicts a first side view of the embodiment shown in FIG. 4a.

FIG. 4e depicts a second side view of the embodiment shown in FIG. 4a.

FIG. 4f depicts a third side view of the embodiment shown in FIG. 4a.

FIG. 4g depicts a fourth side view of the embodiment shown in FIG. 4a.

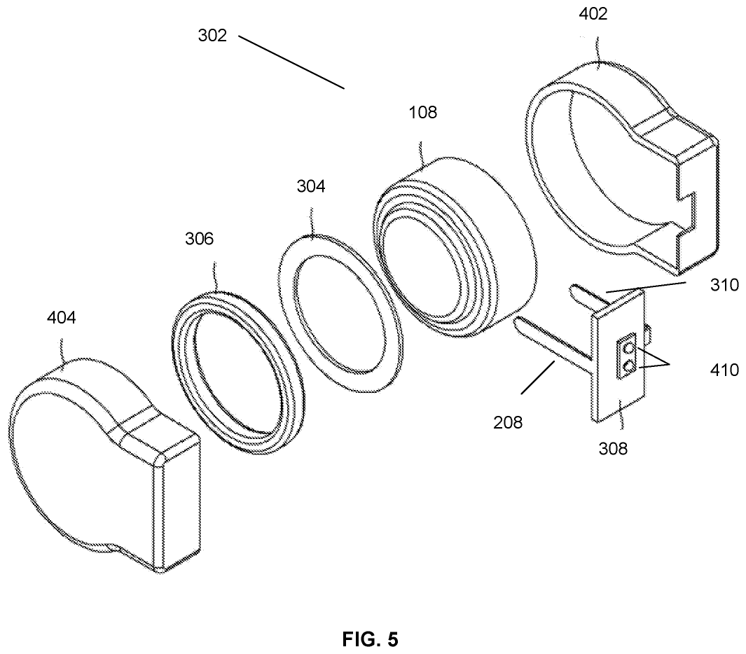

FIG. 5 depicts an expanded assembly view of another embodiment of a battery unit 302. In some embodiments, a battery housing 106 can contain a battery 108 having a top surface and a bottom surface. A ferrite sheet 304 having a top surface and a bottom surface can be placed adjacent to a battery 108, such that the top surface of a ferrite sheet 304 can be in contact with the bottom surface of a battery 108. In some embodiments, a ferrite sheet 304 can have a substantially annular geometry, but in other embodiments can have any other known and/or convenient geometry. A inductive coil 306 having a top surface and a bottom surface can be placed adjacent to a ferrite sheet 304, such that the top surface of an inductive coil 306 can be in contact with the bottom surface of a ferrite sheet 304. A printed circuit board (PCB) 308 can comprise a first contact 208 and a second contact 310, which can be in electrical contact with a battery 108. In such embodiments, a battery unit 302 can be adapted and configured to receive electrical energy and charge a battery 108.

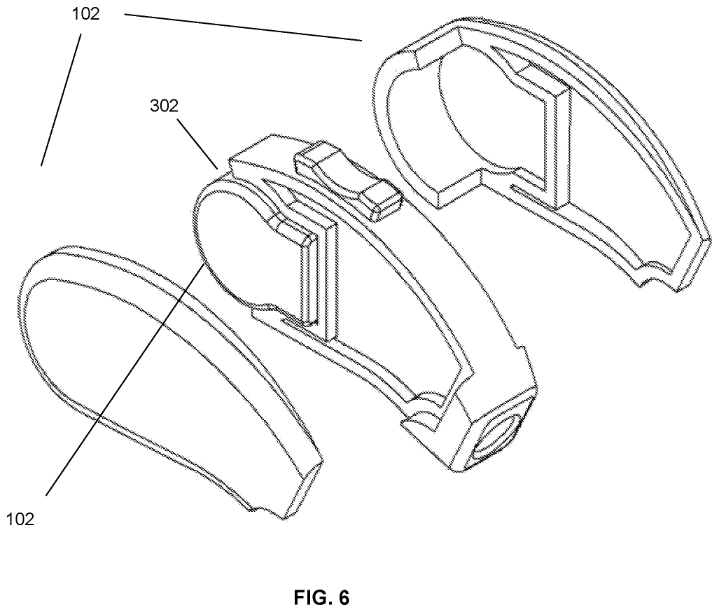

FIG. 6 depicts an expanded assembly view of another embodiment of a battery unit 302 in use in a hearing aid 102. A battery unit 302 can be inserted into the body of a hearing aid 102. In such embodiments, a battery unit housing 106 can be configured to selectively engage with a portion of a hearing aid 102.

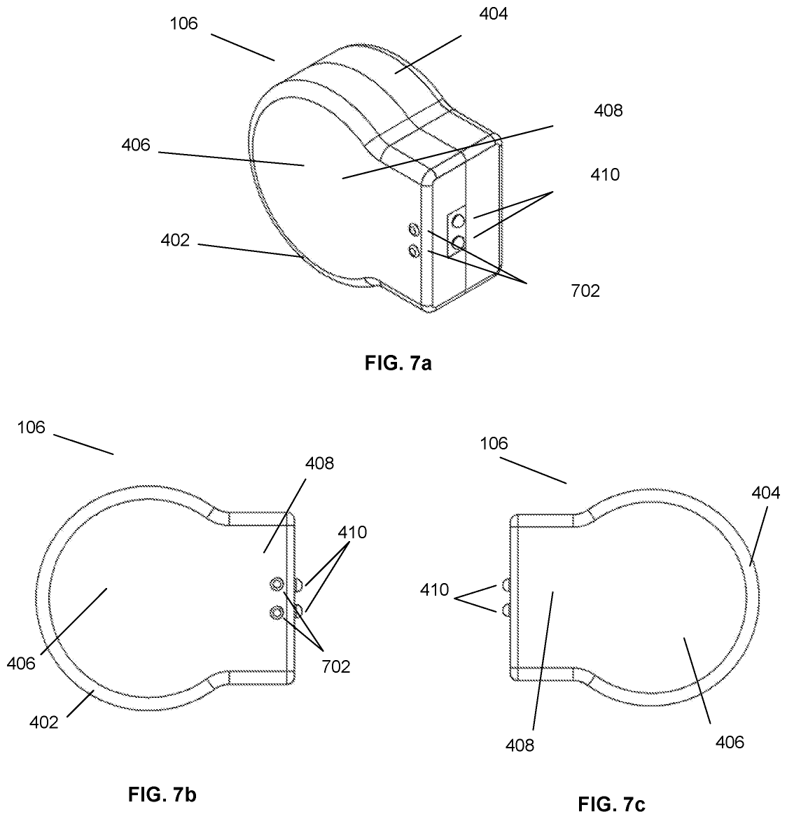

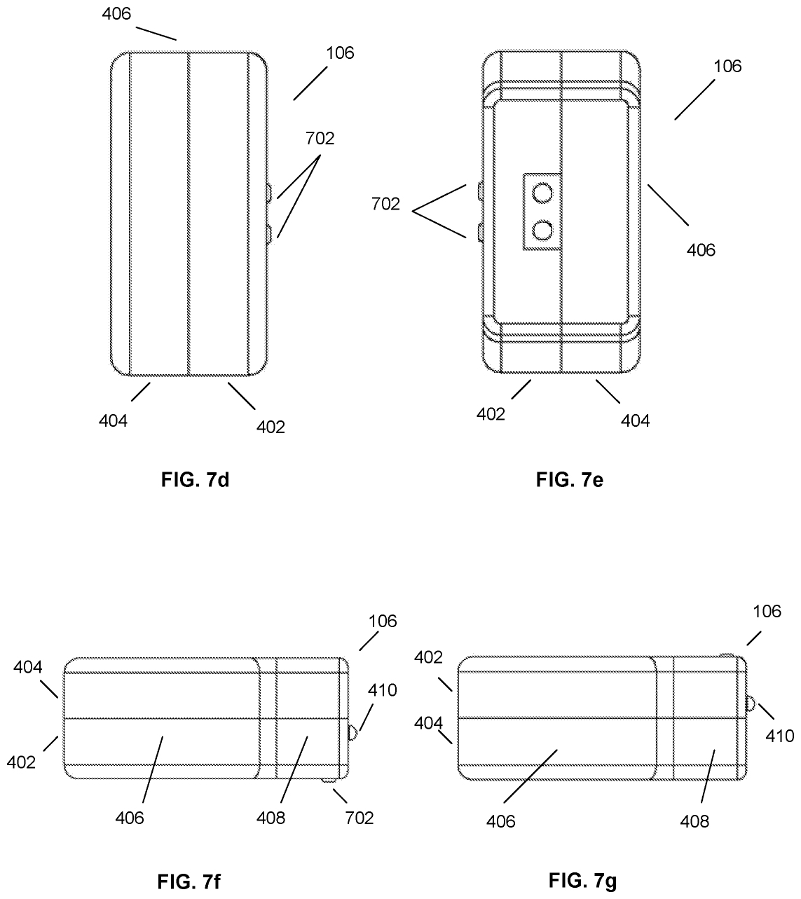

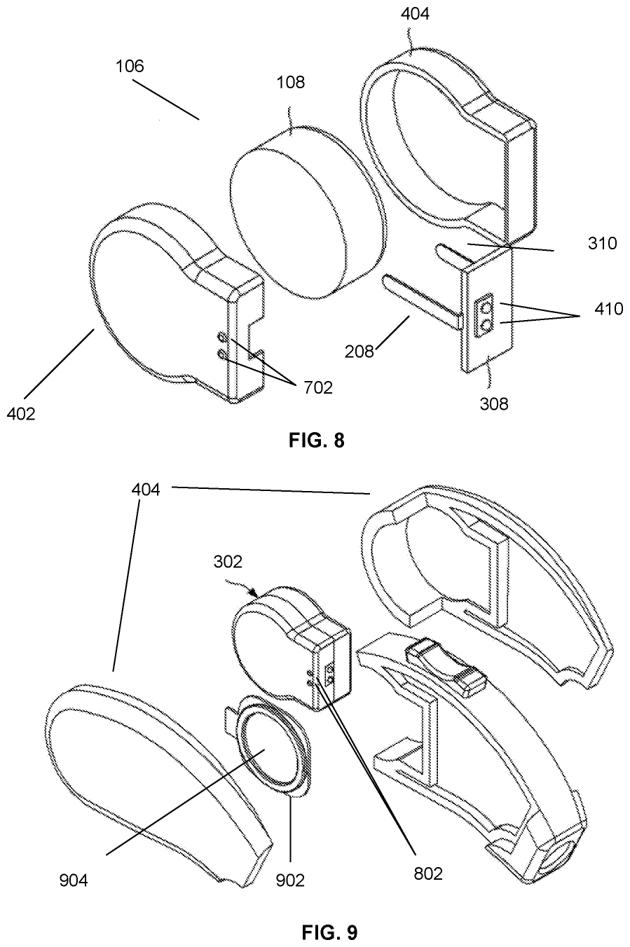

FIG. 7a depicts another embodiment of a battery housing 106. In the embodiment shown, a battery housing 106 can comprise a first section 402 and a second section 404, which can be of substantially congruent geometry and selectively engage with each other, but in other embodiments can be any other known and/or geometry. In some embodiments, a first section 402 and a second section 404 can securely and temporarily connect via a friction fit, tab-and-slot, threaded connector, adhesive, or any other known and/or convenient mechanism.

As shown in FIG. 7a, a battery housing 106 can comprise a substantially rounded portion 406 and a protruding substantially rectangular portion 408. A rounded portion 406 can be substantially circular and have a radius substantially proportional to a battery 108, but in other embodiments can have any other known and/or convenient geometry. In such embodiments, a substantially rectangular portion 408 can extend substantially radially from a rounded portion 406, but in other embodiments can extend tangentially or in any other known and/or convenient configuration. In some embodiments, a pair of external electrical contacts 410 can be located at the distal end of a rectangular portion 408, proximal to the joint line between a first section 402 and a second section 404, but in other embodiments can be in any other known and/or convenient location. In the embodiment shown, a second pair of contacts 802, which can be located proximal to the distal edge of the external face of a first section 402, or any other known and/or convenient location. In some embodiments, a second pair of contacts 702 can also be substantially aligned with a first pair of electrical contacts 410, as shown in FIG. 7a, but in other embodiments can be positioned in any other known and/or convenient location.

FIG. 7b depicts a top view of the embodiment shown in FIG. 7a, showing the face of a first section 402.

FIG. 7c depicts a bottom view of the embodiment shown in FIG. 7a, showing the face of a second section 404.

FIG. 7d depicts a first side view of the embodiment shown in FIG. 7a.

FIG. 7e depicts a second side view of the embodiment shown in FIG. 7a.

FIG. 7f depicts a third side view of the embodiment shown in FIG. 7 a.

FIG. 7g depicts a fourth side view of the embodiment shown in FIG. 7a.

FIG. 8 depicts an expanded assembly view of another embodiment of a battery housing unit 302. In some embodiments, a battery housing 106 can contain a battery 108 having a top surface and a bottom surface. In some embodiments, a battery housing 106 can comprise a first section 402 and a second section 404, which can selectively engage with each other to contain a battery 108 having a top surface and a bottom surface. A first electrical contact 208 and a second electrical contact 310 can be in electrical contact with a top surface and a bottom surface of a battery 108. A PCB 308, can be in electrical communication with a first electrical contact 208 and a second electrical contact 310 and a pair of external electrical contacts 410.

FIG. 9 depicts an expanded assembly view of another embodiment of a battery housing unit 302 in use in a hearing aid 102. In this embodiment, a hearing aid 102 can have an internal inductive coil 902. In such embodiments, and inductive coil 902 and a ferrite sheet 904 can be in electrical communication with a battery 108 via second pair of contact points 802, but exterior to battery housing 106, wherein an inductive coil 1002 and ferrite sheet 1004 can be adapted and configured to receive electrical energy and charge a battery 108.

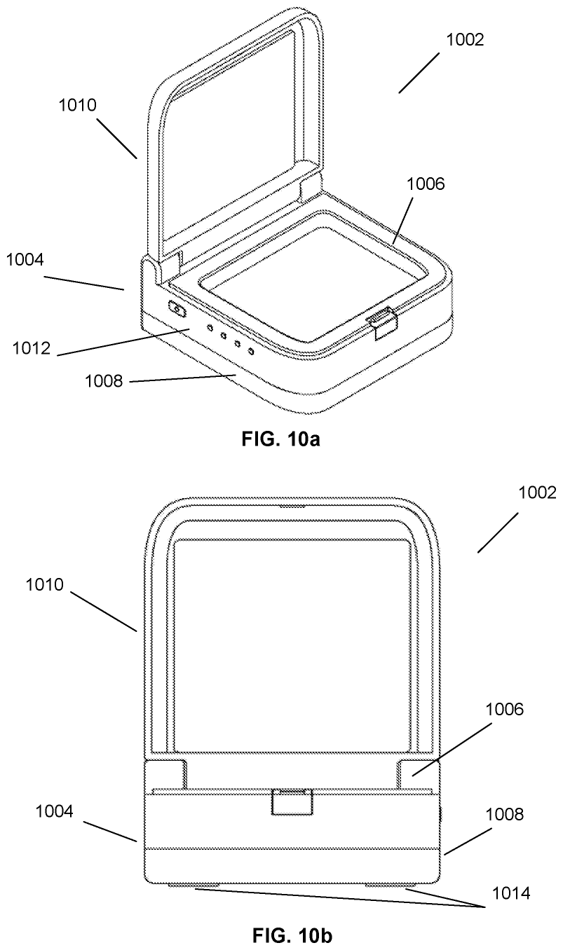

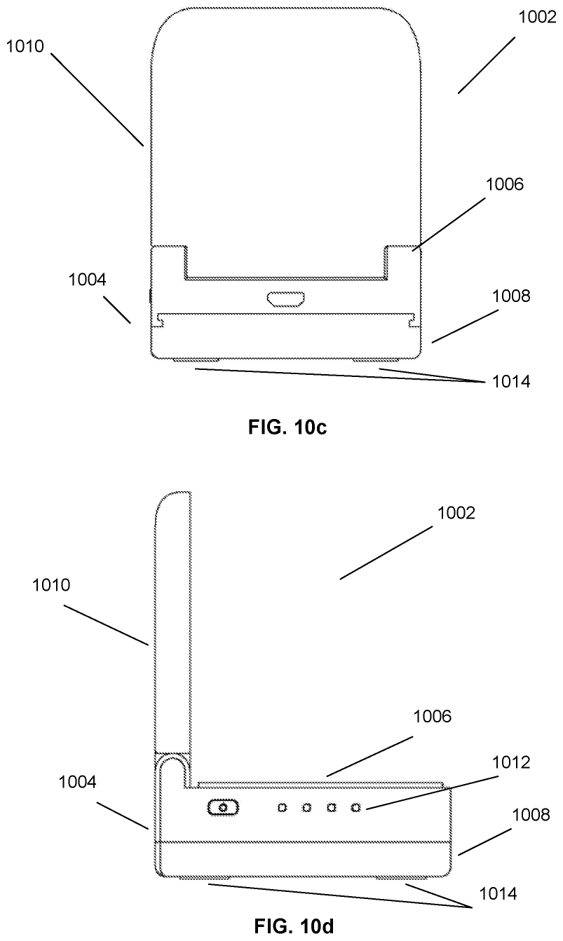

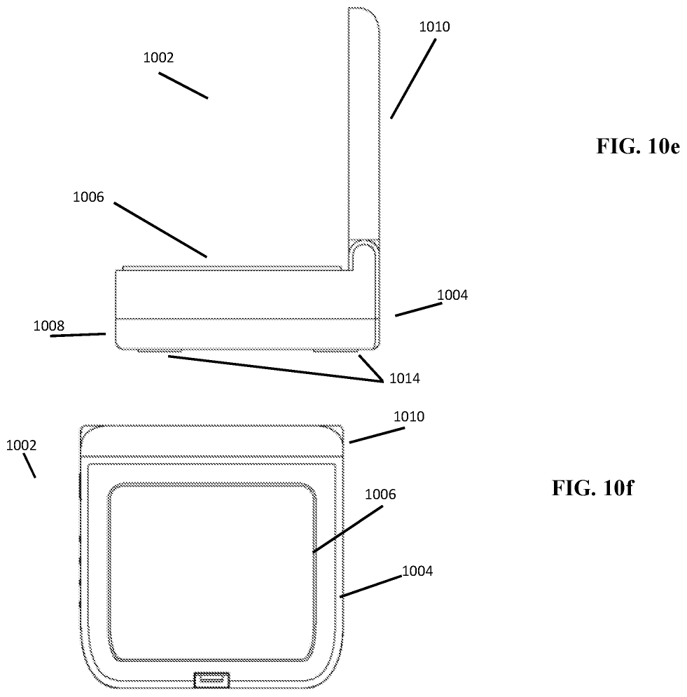

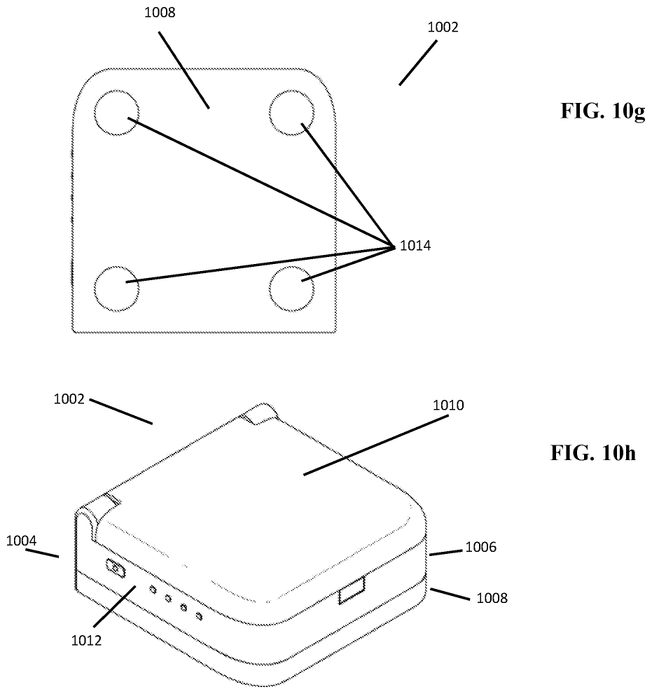

FIG. 10a depicts a perspective view of an embodiment of a battery charging system adapted and configured for use with a rechargeable hearing aid. In the embodiment shown, a charging case 1002 can comprise a base 1004 having a housing chamber 1006 and a power source 1008, and a cover 1010. In some embodiments, the configuration of a power source 1008 can depend on factors such as, but not limited to, desired shape and size, the number of charging cycles required to charge a battery 108, the capacity of a rechargeable battery 108, charging magnetic coupling parameters, and system efficiency. In some embodiments, a power source 1008 can be interchangeable, but in other embodiments can be integrated with, affixed to, embedded in, or coupled with a housing chamber 1006 in any other known and/or convenient manner.

In the embodiment depicted, a cover 1010 can be pivotally coupled with a base 1004. However, in alternate embodiments, a cover 1010 can be selectively coupled with a base 1004 in any known and/or convenient and/or desired manner. In still further alternate embodiments, a cover 1010 may be absent. A housing chamber 1006 of a base 1004 can comprise any known and/or convenient and/or desired components, adapted and configured such that a housing chamber 1006 can inductively transfer energy to any known and/or convenient inductively chargeable device in electrical communication with a housing chamber 1006. A base 1004 can also comprise a user interface 1012, which can comprise lights, buttons, or any other known and/or convenient devices to indicate and/or control charging. In some embodiments, a charging case 1002 can have a substantially rectangular geometry, but in other embodiments can have any other known and or convenient geometry.

As shown in FIGS. 10a-i, a base 1104 can comprise a housing chamber 1006 and a power source 1008. In some embodiments, as shown in FIGS. 10c and 10i, a power source 1008 can be interchangeable and removably coupled to a housing chamber 1006 via a slidable coupling mechanism comprising a tongue-and-groove configuration, but in other embodiments can have a click-fit, friction-fit, or any other known and convenient device. However, in alternate embodiments, the present hearing aid battery charging system can be directly powered via any known and/or convenient and/or desired power source. In the embodiment depicted, a power source 1008 can be a substantially flat rechargeable battery that can be selectively and slideably coupled with a housing chamber 1006 such that a power source 1008 can be removed and replaced and/or removed and charged, and/or in some embodiments, charged while in operative communication with a housing chamber 1006 in a base 1004.

In some embodiments, a power source 1008 can have footers 1014 placed on the bottom surface to prevent scratches or other damages to surfaces where a charging case 1002 is placed.

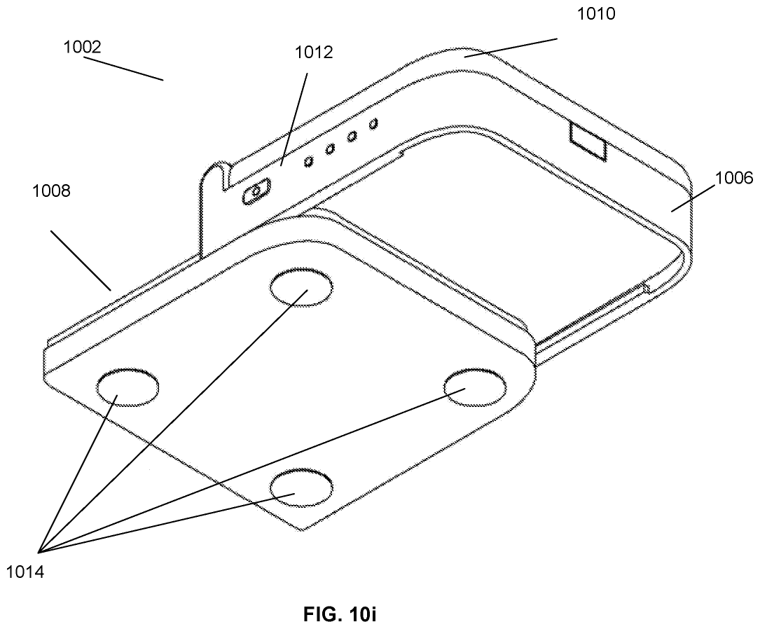

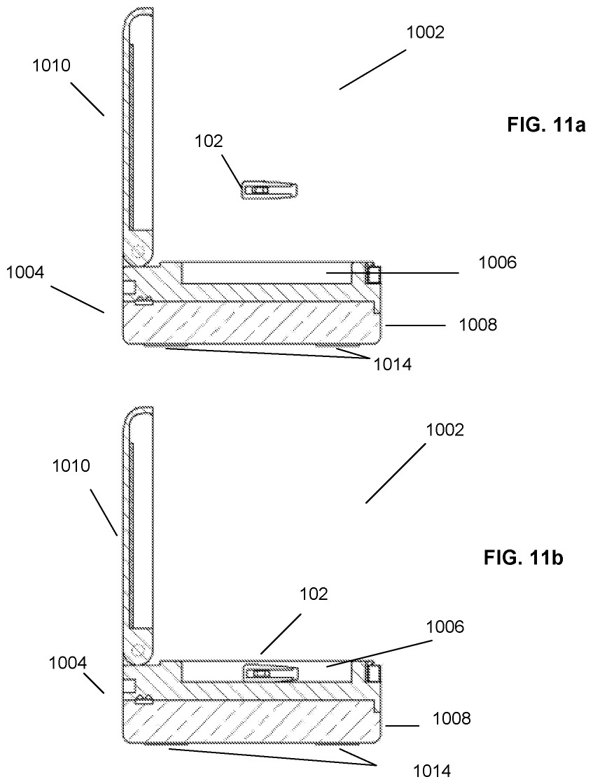

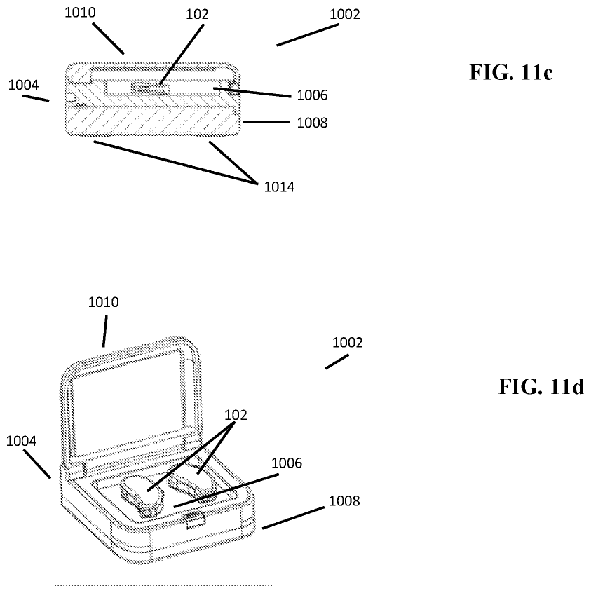

FIGS. 11a-d depict an embodiment of a charging case 1002 in use. In FIG. 11a, at least one wireless, rechargeable hearing aid 102 containing a rechargeable battery unit 302 can be placed in a housing chamber 1006. A power source 1008 can be removably coupled under a housing chamber 1006, but in other embodiments can be positioned in any other known and/or convenient location. As shown in FIG. 11b, a user can close a cover 1010 to secure a hearing aid 102 in a case 1002. A cover 1010 can be secured via a magnetic, clip, spring biased, friction-fit, or any other known and/or convenient device.

As shown in FIG. 11c, a hearing aid 102 can rest inside a housing chamber 1006 proximal to and in electrical communication with a power source 1008, which can charge a battery 108 in a hearing aid 102. This can allow a hearing aid 102 to be recharged while a user is sleeping or otherwise not using hearing aids 102. After a sufficient time to charge a battery 108 in a hearing aid 102, a user can open a case 1002 and retrieve hearing aids 102 ready for use, as shown in FIG. 11d.

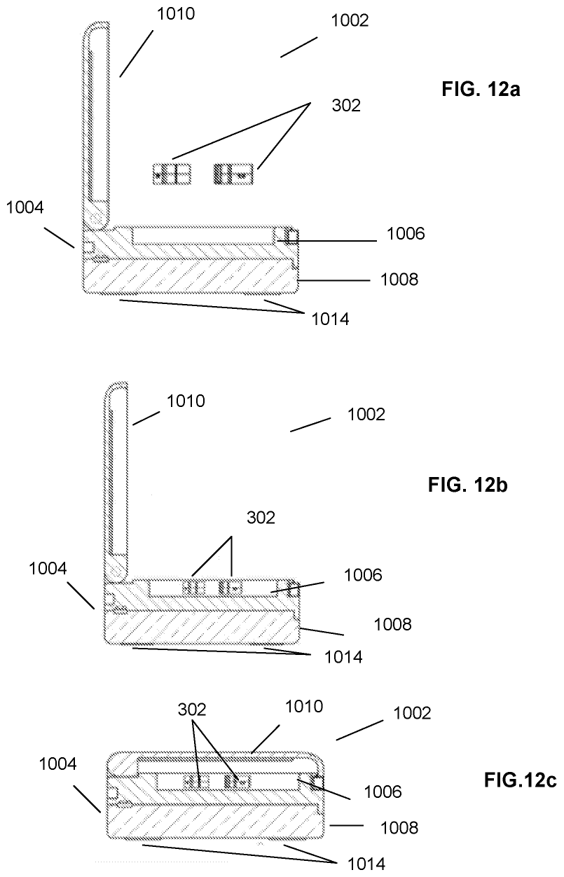

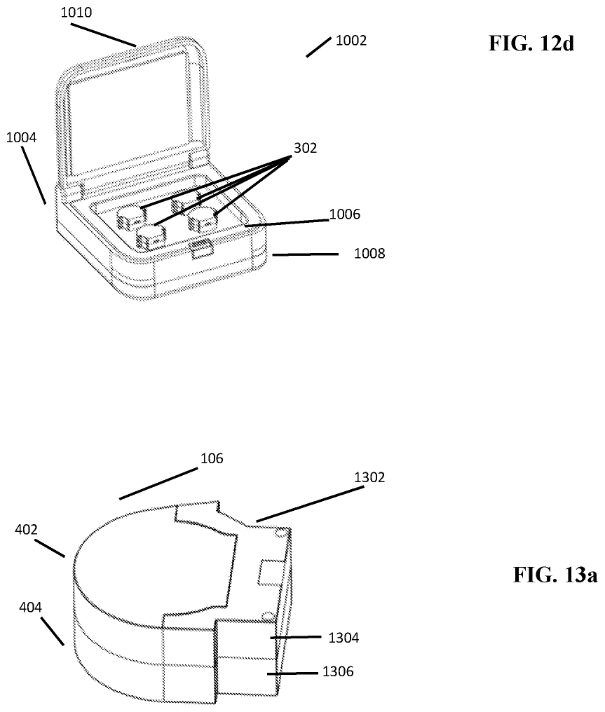

FIGS. 12a-d depict another embodiment of a charging case 1002 in use. In FIG. 12a, at least one rechargeable battery unit 302 can be placed in a housing chamber 1006. A power source 1008 can be removably coupled under a housing chamber 1006. As shown in FIG. 12b, a user can close a cover 1010 to secure a rechargeable battery unit 302 in a case 1002. A cover 1010 can be secured via a magnetic, clip, spring biased, friction-fit, or any other known and/or convenient device.

As shown in FIG. 12c, a rechargeable battery unit 302 can rest inside a housing chamber 1006 proximal to and in electrical communication with a power source 1008, which can charge a rechargeable battery unit 302. This can allow a rechargeable battery unit 302 to be recharged while a user is sleeping or otherwise not using hearing aids 102. After a sufficient time to charge a rechargeable battery unit 302, a user can open a case 1002 and retrieve rechargeable battery unit 302 ready for use, as shown in FIG. 12d.

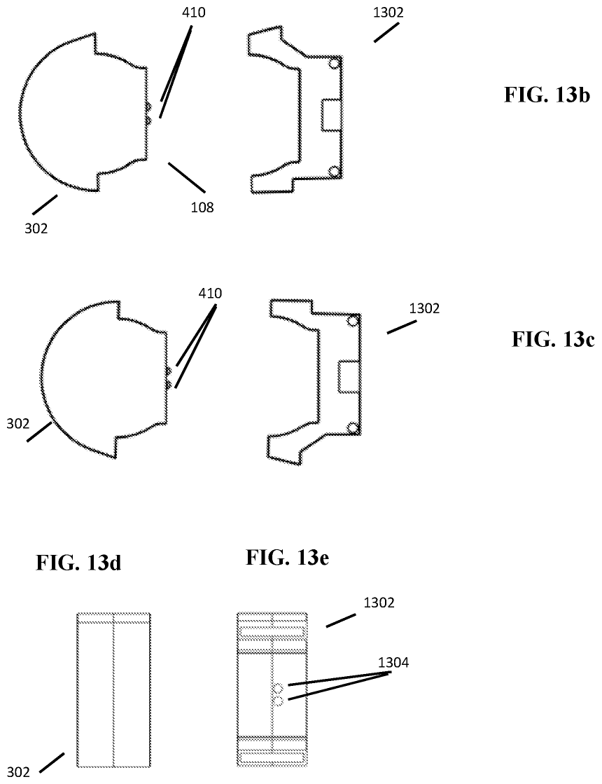

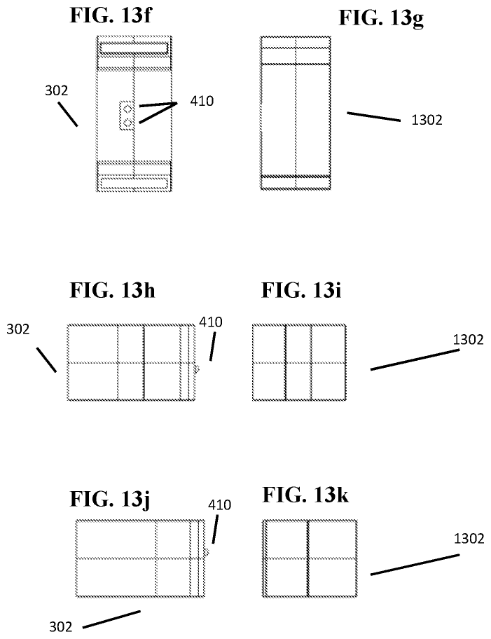

FIG. 13a depicts a perspective view of another embodiment of the present device. A battery housing unit 302 can be selectively engaged with and in electrical communication with an adaptor unit 1302, which can serve as a physical and electrical interface between a rechargeable battery unit 302 and a hearing aid 102. In some embodiments, an adaptor unit 1302 can be fixed inside the housing of a hearing aid 102, but in other embodiments can be removably attached and/or place at any other known and/or convenient location. In such embodiments, a user can charge a battery unit 302 and attach to a hearing aid 102 to use and detach to re-charge a battery 108.

FIG. 13b depicts an expanded top view of the embodiment shown in FIG. 13a.

FIG. 13c depicts an expanded bottom view of the embodiment shown in FIG. 13a.

FIGS. 13d and 13e depict a first side expanded view of the embodiment shown in FIG. 13a. As shown in FIG. 13e, an adaptor 1302 can have a set of contacts 1304 that can be in electrical communication with contacts 410 in a battery unit 302.

FIGS. 13f and 13g depict a second side expanded view of the embodiment shown in FIG. 13a.

FIGS. 13h and 13i depict a third side expanded view of the embodiment shown in FIG. 13a.

FIGS. 13j and 13k depict a fourth side expanded view of the embodiment shown in FIG. 13a.

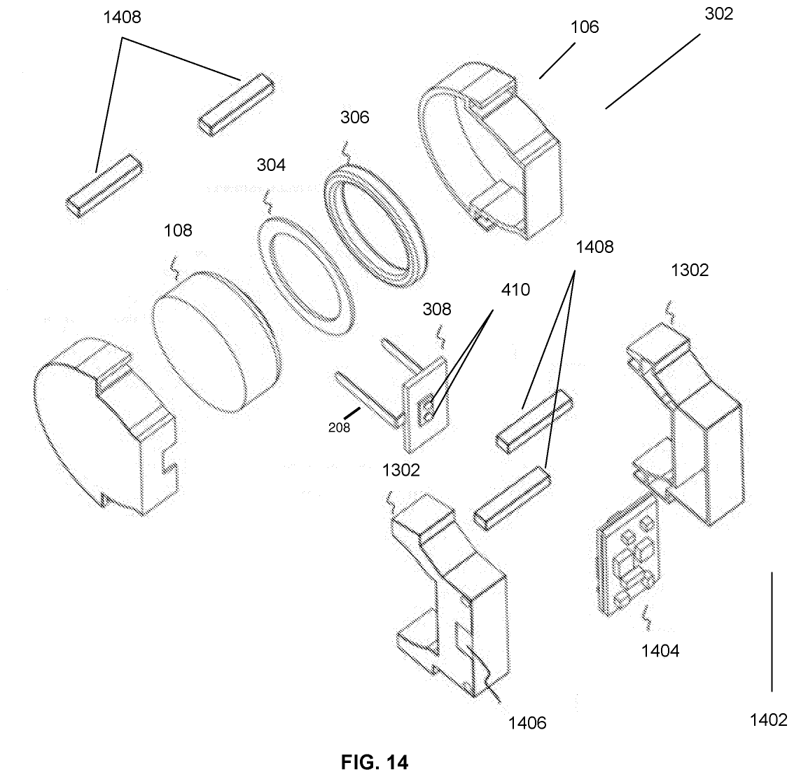

FIG. 14 depicts an expanded perspective view of another embodiment of a battery housing unit 302 and an adaptor unit 1402. An adaptor PCB 1404 can be configured to regulate the voltage of a rechargeable battery 108 to match the operating voltage of a hearing aid 102. An adaptor PCB 1404 can be in electrical communication with a battery unit 302 via contact points 410. An adaptor can be in electrical communication with a hearing aid 102 via contact points 1406. In some embodiments, magnets 1408 can mechanically connect a battery housing unit 302 with an adaptor unit 1402, but in other embodiments can be used to perform any other known and/or convenient mechanical and/or electrical function.

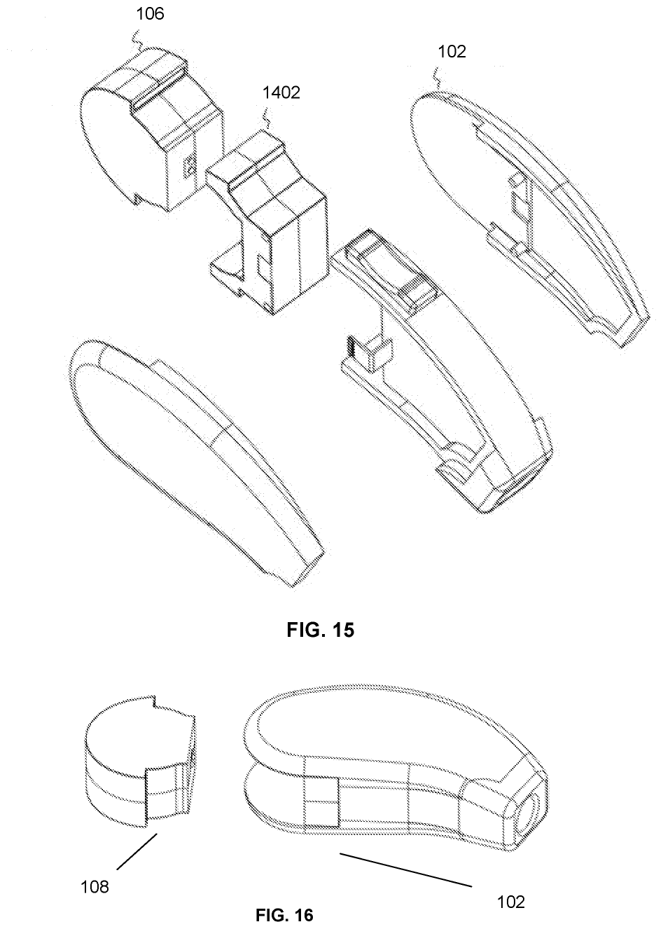

FIG. 15 depicts an expanded perspective view of another embodiment of the present device. A rechargeable battery housing 106 can be removably connected to an adaptor 1402. A housing 106 and adaptor 1402 can be removably fitted into the main body of a hearing aid 102.

FIG. 16 depicts perspective edge view of another embodiment of the present device. As shown in this embodiment, a rechargeable battery housing 106 can be removably connected and fitted directly into the main body of a hearing aid 106.

In operation, a battery housing 106 can be pivoted away from a hearing aid body 102 such that a battery 108 can be accessed or replaced. A rechargeable battery 108 can be installed in a battery housing 106, which can be pivoted back into position within a hearing aid body 102. In operation, a rechargeable battery 108 can be installed in a battery housing 106, which can be positioned within a hearing aid body 102, such that one or more power delivery contact points 402 can be positioned to provide power to a hearing aid 102. A hearing aid 102 can then be placed in operative proximity to an inductive charging surface 110, as shown in FIG. 1a. In operation, when a charging surface 110 is powered, energy can be transferred between inductive charging surface 102 and a battery 108 such that a battery 108 can be charged via any known and/or convenient inductive charging method. In some embodiments, charge rate can be dependent on parameters, such as, but not limited to, charging current and profile. The charge rate can also vary with factors such as, but not limited to, battery capacity, desired charging time, charging magnetic coupling and system efficiency, and battery life expectation.

In some embodiments, such as shown in FIG. 3, a battery housing 106 can comprise a battery 108 in electrical communication with an inductive coil 306, which can be adapted and configured to receive electrical energy and charge a battery 108.

In alternate embodiments, as shown in FIG. 9, a hearing aid housing 102 can contain an inductive coil 902 positioned such that when a battery 108 is contained within a hearing aid 102, an inductive coil 902 can be in electrical communication with a battery 108 such that a battery 108 can be charged via the an inductive coil 902 and ferrite sheet 904.

Some embodiments of the present system, as shown in FIG. 10, can further comprise a power source 1008, which can be removeable and rechargeable, that can be coupled with a base 1004 in any known, convenient and/or desired manner. However, in alternate embodiments, a battery charging system can be directly powered via any known, convenient and/or desired power source 1008. In the embodiment depicted, a power source 1008 can be a rechargeable battery that can be selectively coupled with a base 1004 such that a power source 1008 can be removed and replaced and/or removed and charged. In some embodiments, a power source 1008 can be slidably connected to a base 1004, but in other embodiments can be removeable connected by any other known and/or convenient method. In some embodiments, a power source 1008 can be charged while in operative communication with a base 1004.

In embodiments where a power source 1008 is a substantially flat rechargeable battery, a power source 1008 can be coupled with the base 1004 of a charging case 1002 and one or more hearing aids 102 comprising inductively rechargeable batteries 108 or any other known and/or convenient components can be placed within a housing chamber 1006 of a base 1004 an a lid 1010 (if present) can be closed. A power source 1008 (i.e., a substantially flat rechargeable battery) can then transfer energy via inductive power transfer to rechargeable batteries 108 in hearing aids 102. In some embodiments, a battery charging system can comprise user interface devices 1012, such as, but not limited to, an on/off switch and/or can comprise one or more indicator lights adapted and configured to provide a user with feedback, such as whether the device is on or off, charging and/or charging is complete.

In some embodiments, as shown in FIG. 9, a rechargeable battery 108 can be installed in a battery housing 106, and the battery housing 106 and external inductive coil 902 and ferrite sheet 904 can be positioned within the hearing aid body 102 such that the one or more power delivery contact points 410 are positioned to provide power to a hearing aid 102. A hearing aid 102 can then be placed in operative proximity to an inductive charging surface 110. In operation, when a charging surface 110 is powered, energy can be transferred between an inductive charging surface 110 and a rechargeable battery 108 such that a battery 108 is charged via any known and/or convenient inductive charging method.

In operation, as shown in FIGS. 11a-d, a power source 1008 can be removably coupled with a housing chamber 1006 to comprise the base 1004 of a charging case 1002 and one or more hearing aids 102 comprising inductively chargeable batteries 108 or components can be placed within a housing chamber 1006 of the base and a lid 1010 (if present) can be closed. An interchangeable power source 1008 can then transfer energy via inductive power transfer to batteries) 108 in the one or more hearing aids 102. In some embodiments a battery charging system 102 can comprise an on/off switch and/or can comprise one or more indicator lights adapted and configured to provide a user with feedback, such as whether the device is on or off, charging and/or charging is complete 1012.

Although exemplary embodiments of the invention have been described in detail and in language specific to structural features and/or methodological acts above, it is to be understood that those skilled in the art will readily appreciate that many additional modifications are possible in the exemplary embodiments without materially departing from the novel teachings and advantages of the invention. Moreover, it is to be understood that the subject matter defined in the appended claims is not necessarily limited to the specific features or acts described above. Accordingly, these and all such modifications are intended to be included within the scope of this invention construed in breadth and scope in accordance with the appended claims.

What is claimed is:

1. A rechargeable hearing aid system comprising:
a hearing aid;
a rechargeable battery unit, further comprising a rechargeable battery, a ferrite sheet, and
an inductive charging coil in electrical communication with said rechargeable battery;
and a power source.

2. The system of claim 1, wherein said power source is an inductive charging surface.

3. The system of claim 2, wherein said power source is removably coupled with a case.

4. The system of claim 2, further comprising an adaptor in electrical communication between a rechargeable battery and a hearing aid.

5. The system of claim 1, further comprising a battery unit housing.

6. The system of claim 5, wherein said inductive charging coil and said ferrite sheet are contained within said housing.

7. The system of claim 5, wherein said inductive charging coil and ferrite sheet are located externally to said housing.

8. The system of claim 5, further comprising a case having a lid, housing chamber, and a power source removably coupled to said housing chamber.

9. The system of claim 8, wherein said power source is interchangeable.

10. The system of claim 8, wherein said power source is fixed.

11. The system of claim 9, wherein said power source is a rechargeable battery.

12. The system of claim 10, wherein said power source is a rechargeable battery.

13. A rechargeable hearing aid system, comprising,
a hearing aid;
a rechargeable battery; and,
a case having a lid, a housing chamber, and a power supply;
wherein a hearing aid is placed into said housing chamber, and wherein said power supply is in electrical communication with said rechargeable battery in said hearing aid, such that said rechargeable battery is charged while stored in said housing chamber.

14. The system of claim 13, wherein said battery is removable from said hearing aid and is placed into said housing chamber, where power supply is in electrical communication with said rechargeable battery in said hearing aid, such that said battery is charged while stored in said housing chamber.
